(19) United States
(12) Patent Application Publication
(10) Pub. No.: US 2025/0292204 A1
(43) Pub. Date: Sep. 18, 2025

(54) PRODUCT MANAGEMENT DEVICE, PRODUCT MANAGEMENT METHOD, AND RECORDING MEDIUM

(71) Applicant: NEC Corporation, Tokyo (JP)

(72) Inventor: Tomoki ISHII, Tokyo (JP)

(73) Assignee: NEC Corporation, Tokyo (JP)

(21) Appl. No.: 18/946,089

(22) Filed: Nov. 13, 2024

(30) Foreign Application Priority Data
Mar. 13, 2024 (JP) 2024-038586

(51) Int. Cl. G06Q 10/087; G06V 20/52; G06V 40/20

(52) U.S. Cl. CPC G06Q 10/087; G06V 20/52; G06V 40/20

(57) ABSTRACT

A product management device comprising a memory storing instructions; and a processor connected to the memory and configured to execute the instructions to: acquire shelf monitoring information indicating a change in a display status of a product included in a photographed image based on the photographed image obtained by photographing a product shelf; acquire sales management information of the product; determine a criteri on for generating an alert based on a possibility of including a product whose sales management expiration has expired, the possibility being evaluated based on the shelf monitoring information and the sales management information; and generate an alert of the product based on the criterion.

This application is based upon and claims the benefit of priority from Japanese Patent Application No. 2024-038586, filed on Mar. 13, 2024, the disclosure of which is incorporated herein in its entirety by reference.

### TECHNICAL FIELD

The present disclosure relates to a product management device, a product management method, and a recording medium.

### BACKGROUND ART

Japanese Patent Application Laid-open Publication No. 2019-192126 discloses technology for determining whether a sales management expiration specified based on product attribute information attached to a placement platform surface side on which a product is placed has passed.

### SUMMARY

An object of the present disclosure is to provide a product management device capable of appropriately managing a management expiration regardless of a product display status.

A product management device according to an aspect of the present disclosure includes: a first acquisition means for acquiring shelf monitoring information indicating a change in a display status of a product included in a photographed image based on the photographed image obtained by photographing a product shelf; a second acquisition means for acquiring sales management information of a product; a determination means for determining a criterion for generating an alert based on a possibility of including a product whose sales management expiration has expired, the possibility being evaluated based on the shelf monitoring information and the sales management information; and an output means for generating an alert of the product based on the criterion.

In a product management method according to an aspect of the present disclosure, the method causes a computer to execute: acquiring shelf monitoring information indicating a change in a display status of a product included in a photographed image based on the photographed image obtained by photographing a product shelf; acquiring sales management information of the product; determining a criterion for generating an alert based on a possibility of including a product whose sales management expiration has expired, the possibility being evaluated based on the shelf monitoring information and the sales management information; and generating an alert of the product based on the criterion.

A program according to an aspect of the present disclosure causes a computer to execute acquiring shelf monitoring information indicating a change in a display status of a product included in a photographed image based on the photographed image obtained by photographing a product shelf; acquiring sales management information of the product; determining a criterion for generating an alert based on a possibility of including a product whose sales management expiration has expired, the possibility being evaluated based on the shelf monitoring information and the sales management information; and generating an alert of the product based on the criterion.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration example of a product management device according to the present disclosure;

FIG. 2 is a diagram illustrating a hardware configuration in which the product management device according to the present disclosure is implemented by a computer device and its peripheral devices;

FIG. 3 is an example of a screen of an alert output by an output unit in the present disclosure;

FIG. 4 is an example of a screen of an alert output by an output unit in the present disclosure; FIG. 5 is an example of a screen of an alert output by an output unit in the present disclosure;

FIG. 6 is a flowchart illustrating an operation of the product management device according to the present disclosure;

FIG. 7 is a block diagram illustrating a configuration example of the product management device according to the present disclosure; and

FIG. 8 is a flowchart illustrating an operation of the product management device according to the present disclosure.

### EXAMPLE EMBODIMENT

Hereinafter, example embodiments of a product management device, a product management method, and a non-transitory recording medium recording a program according to the present disclosure will be described in detail with reference to the drawings. The present example embodiment does not limit the disclosed technology.

The product management device of the present example embodiment is a device for supporting management of a sales management expiration of a product displayed on a product shelf of a store. More specifically, the product management device notifies a timing for confirming the sales management expiration of the store clerk. The store is, for example, a retail store such as a supermarket or a convenience store. The sales management expiration is an expiration by which a product can be sold in a store, and varies depending on the product.

Generally, for a product whose sales management expiration is as long as several months after the product is displayed, it is necessary to confirm the sales management expiration every predetermined period by dividing the period until the sales management expiration. The necessity of confirming the sales management expiration changes depending on the change in the display status of the product. That is, when a product is replenished, there is a possibility that a product whose sales management expiration is close and a product whose sales management expiration is not close are mixed. Since the customer tends to avoid purchasing a product whose sales management expiration is close, when the customer picks up the product, the product whose sales management expiration is close may be placed at the bottom of the product shelf. There is a possibility that the display status is disturbed when the customer picks up the product.

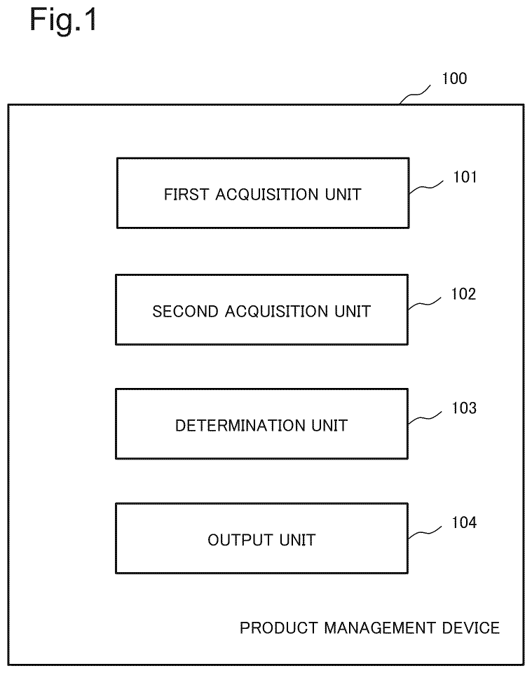

FIG. 1 is a block diagram illustrating a configuration example of a product management device 100 in the present disclosure. Referring to FIG. 1, the product management device 100 includes a first acquisition unit 101, a second acquisition unit 102, a determination unit 103, and an output unit 104.

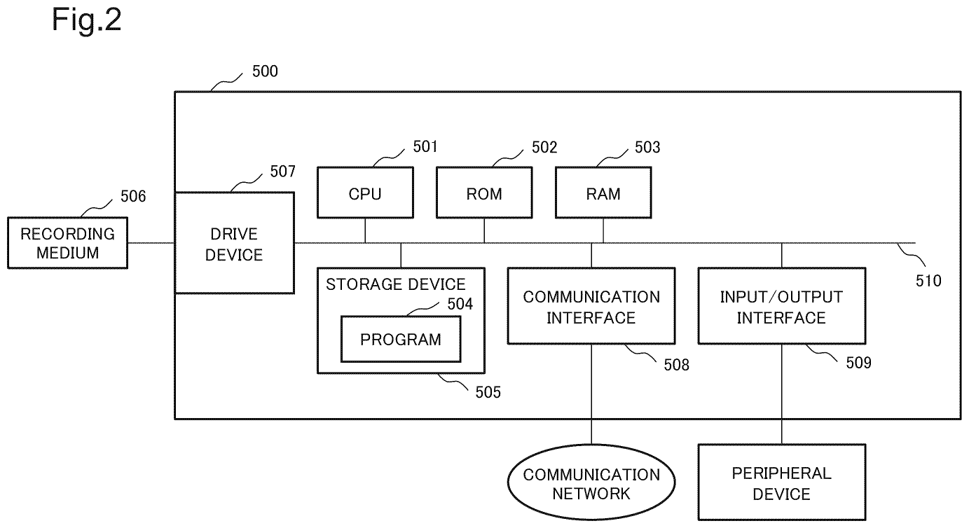

FIG. 2 is a diagram illustrating an example of a hardware configuration in which the product management device 100 in the present disclosure is achieved by a computer device 500 including a processor. As illustrated in FIG. 2, the product management device 100 includes a central processing unit (CPU) 501, a memory such as a read only memory (ROM) 502 and a random access memory (RAM) 503, a storage device 505 such as a hard disk that stores a program 504, a communication interface 508 for network connection, and an input/output interface 509 that inputs and outputs data. In the present disclosure, the product management device 100 is connected to each component via a bus 510. The product management device 100 illustrated in FIG. 1 can also be configured by cloud computing or the like.

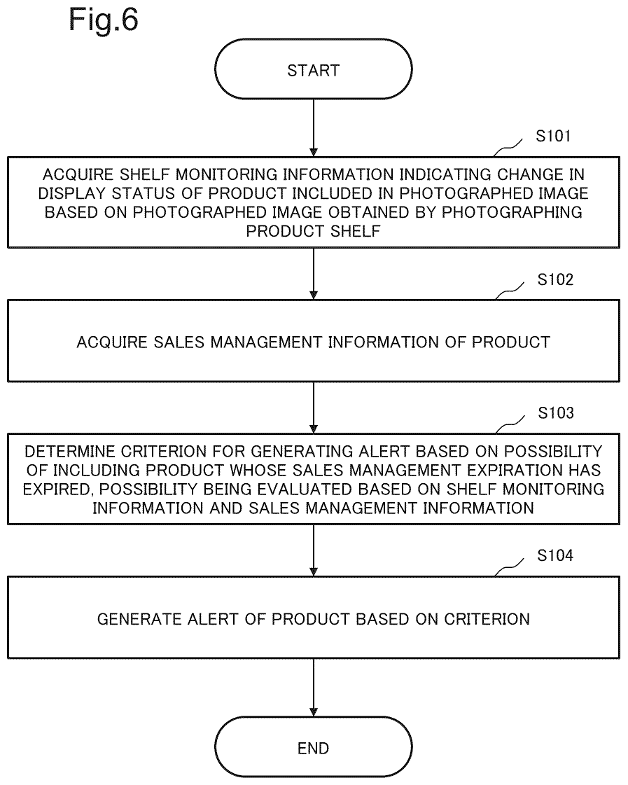

The CPU 501 operates the operating system to control the entire product management device 100 according to the present disclosure. The CPU 501 reads a program and data from a recording medium 506 mounted on, for example, a drive device 507 to a memory. The CPU 501 functions as the first acquisition unit 101, the second acquisition unit 102, the determination unit 103, the output unit 104, and a part thereof in the present disclosure, and executes processing or commands in the flowchart illustrated in FIG. 6 to be described later based on a program.

The recording medium 506 is, for example, an optical disk, a flexible disk, a magnetic optical disk, an external hard disk, a semiconductor memory, or the like. A semiconductor memory or the like which is a part of the recording medium is a non-volatile storage device, and records a program therein. The program may be downloaded from an external computer (not illustrated) connected to a communication network.

As described above, the product management device 100 illustrated in FIG. 1 is implemented by the computer hardware illustrated in FIG. 2. However, the means for implementing each unit included in the product management device 100 of FIG. 1 is not limited to the configuration described above. The product management device 100 may be implemented by one physically coupled device, or may be implemented by a system by connecting two or more physically separated devices in a wired or wireless manner.

The first acquisition unit 101 is a means that acquires shelf monitoring information indicating a change in a display status of a product included in a photographed image based on the photographed image obtained by photographing the product shelf. The first acquisition unit 101 recognizes the product ID information of each product included in the photographed image of the product shelf and specifies the product. The first acquisition unit 101 analyzes the photographed image and detects a change in the display status of the specified product. As a change in the display status of the product, the first acquisition unit 101 acquires shelf monitoring information of at least one of replenishment of the product, face correction of the product, picking up of the product, and returning of the product. The face correction of a product means that a surface on which a label of the product is attached faces the front. The first acquisition unit 101 acquires shelf monitoring information of a product in units of stock keeping unit (SKU), for example. The first acquisition unit 101 outputs the acquired shelf monitoring information to the determination unit 103. In a case where the same product is displayed on a plurality of product shelves in different places, the first acquisition unit 101 acquires shelf monitoring information obtained from a photographed image obtained by photographing each product shelf.

The first acquisition unit 101 may specify whether the change in the display status of the product has been made by the customer or the store clerk. For example, the first acquisition unit 101 acquires information on whether the person is a customer or a store clerk using a known method based on clothes of the person who touches the product.

In a case where the customer changes the display status of the product, the first acquisition unit 101 may detect an action that disturbs the display status of the product and count the number of times. Specifically, the first acquisition unit 101 detects, as the action of disturbing the display status, an action such as taking the product from the back side of the product shelf, returning the product taken in hand to the product shelf, or placing the product displayed in another place.

In a case where the store clerk changes the display status of the product, the first acquisition unit 101 may detect an action to correct the display status of the product and count the number of times. For example, the first acquisition unit 101 detects alignment of products or face correction of products as an action to correct the display status.

The second acquisition unit 102 is a means that acquires sales management information of the product. The second acquisition unit 102 acquires, from a POS system such as a store computer installed in a store, the sales management information of each product included in a photographed image of the product shelf. The second acquisition unit 102 acquires, as the sales management information, for example, the inventory quantity of the product, the inventory quantity of the similar product, the sales quantity, the sales management expiration, the expiration date, and the like. The second acquisition unit 102 outputs the acquired sales management information to the determination unit 103.

The second acquisition unit 102 may acquire discount information of a product as the sales management information. The discount information includes a reason for the discount. The second acquisition unit 102 acquires a reason such as whether the discount has been given before disposal or whether the discount has been given by a coupon or a campaign. In a case where a product is discounted before disposal, it is considered that the product has a risk of including a product whose sales management expiration has expired. On the other hand, in a case where a discount has been given by a coupon or a campaign, it is considered that there is little risk that a product whose sales management expiration has expired is included because it is not intended to be sold out quickly.

The second acquisition unit 102 may acquire, as the sales management information, information of a caution-needed product for which confirmation of a sales management expiration is more necessary. The caution-needed product is, for example, a product for which the sales management expiration is less than a predetermined number of days, a product for which the inventory quantity is equal to or greater than a predetermined quantity and which the store intends to sell, a product for which the sales management expiration has passed in the past, or the like. The second acquisition unit 102 may receive an input of a product desired to be managed as a caution-needed product from an application program for managing a sales management expiration by a store, or may acquire information of a caution-needed product satisfying a preset condition from a database storing sales management information.

The determination unit 103 is a means that determines a criterion for generating an alert based on a possibility of including a product whose sales management expiration has expired, the possibility being evaluated based on the shelf monitoring information and the sales management information. For example, the determination unit 103 evaluates a possibility of including a product whose sales management expiration has expired, based on the shelf monitoring information and the sales management information, in units of SKU.

For example, in a case of evaluating that there is a possibility that a product whose sales management expiration has expired is included, the determination unit 103 determines to generate an alert with a criterion lower than a preset criterion for generating an alert (a condition under which an alert is likely to occur). For example, the determination unit 103 determines to generate an alert at a stage earlier than a preset alert generation timing. The determination unit 103 may appropriately determine the timing to generate an alert by a score value to be described later or specific values of the shelf monitoring information and the sales management information.

On the other hand, in a case where the determination unit 103 evaluates that there is a low possibility that a product whose sales management expiration has expired is included, the determination unit may determine to generate an alert with a higher criterion (a condition under which an alert is less likely to occur) than a preset criterion for generating an alert. For example, the determination unit 103 determines to generate an alert at a later timing than the preset timing to generate an alert. Similarly, the determination unit 103 may appropriately determine the timing to generate an alert based on the score value and the specific values of the shelf monitoring information and the sales management information.

Hereinafter, a method of determining a criterion for generating an alert by the determination unit 103 will be described, but a criterion for generating an alert may be determined by other methods.

The determination unit 103 may evaluate a possibility of including an expired product in a case where a specific condition of the shelf monitoring information and the sales management information satisfies a predetermined condition. The determination unit 103 may calculate a score value indicating the possibility of including a product whose sales management expiration has expired, by using a plurality of pieces of the shelf monitoring information and the sales management information. That is, the determination unit 103 adds the score value in a case where the conditions of the shelf monitoring information and the sales management information are relevant to a condition that may include a product whose sales management expiration has expired. On the other hand, the determination unit 103 subtracts the score value in a case where the conditions of the shelf monitoring information and the sales management information are unlikely to include a product whose sales management expiration has expired. Then, if the calculated score value is equal to or greater than a predetermined value, the determination unit 103 evaluates that there is a possibility of including an expired product, and if the calculated score value is less than the predetermined value, the determination unit evaluates that there is a low possibility of including an expired product.

Specifically, for example, in a case where the number of times of detecting an action that disturbs the display status of the product is equal to or greater than a predetermined number of times, the determination unit 103 adds the score value. This is because it is considered that the more the number of times that the action disturbing the display status of the product has been detected by the determination unit 103, the higher the possibility that the expired product is included. For example, the determination unit 103 adds the score value in a case where the sales quantity in the predetermined period is less than the predetermined quantity by using the sales quantity of the product or the similar product. This is because it is considered that the less the movement of the product, the higher the possibility that the expired product is included. The determination unit 103 adds the score value in a case where the number of days until the sales management expiration of the product is less than a predetermined number of days. For example, when the number of times of replenishment of the product in a certain period is equal to or greater than a predetermined number of times, the determination unit 103 adds the score value. This is because as the number of times of replenishment increases, there is a possibility that an old product is placed on the back side.

On the other hand, the determination unit 103 subtracts the score value in a case where the number of times of detecting the action of correcting the displaying of the product is equal to or greater than a predetermined number of times. This is because it is considered that the more the number of times the action of correcting the display status of the product is detected, the lower the possibility that the expired product is included. For example, the determination unit 103 subtracts the score value in a case where the sales quantity in the predetermined period is equal to or greater than the predetermined quantity by using the sales quantity of the product or the similar product. This is because it is considered that the more the movement of the product, the lower the possibility that the expired product is included. The determination unit 103 subtracts the score value in a case where the number of days until the sales management expiration of the product is equal to or greater than a predetermined number of days. For example, when the number of times of replenishment of the product in a certain period is less than a predetermined number of times, the determination unit 103 subtracts the score value. The determination unit 103 subtracts the score value when the number of times of face correction of the product is equal to or greater than a predetermined number of times. This is because it is considered that as the number of times of face correction of a product increases, the display status is corrected by the store clerk, and the possibility of including an expired product decreases.

The example of addition and subtraction of the score value described above is an example, and the score value may be added or subtracted under other conditions. The score value may be calculated according to a plurality of conditions, or the score value may be calculated according to one condition.

The output unit 104 is a means that generates an alert of a product based on the criterion. The output unit 104 causes any output device of the store to generate an alert for confirming the sales management expiration of the product or urging specific work. The output unit 104 may generate an alert in a terminal possessed by a person in charge of product replenishment. The output unit 104 may generate different alerts depending on the number of days until the sales management expiration. The output unit 104 may change the strength of the alert or may change the work content instructed to the store clerk according to the number of days until the sales management expiration. For example, the output unit 104 outputs an instruction of face correction in a case where the number of days until the sales management expiration is equal to or greater than a predetermined number of days, outputs an instruction of product discount in a case where the number of days until the sales management expiration is less than the predetermined number of days, and outputs an instruction of product removal in a case where the sales management expiration has passed.

The output unit 104 may display the information of the alert target product together with the alert type or the management expiration, or may display a place where the alert target product is displayed. The output unit 104 may display the display position on the store map or the product shelf as the place where the alert target product is displayed.

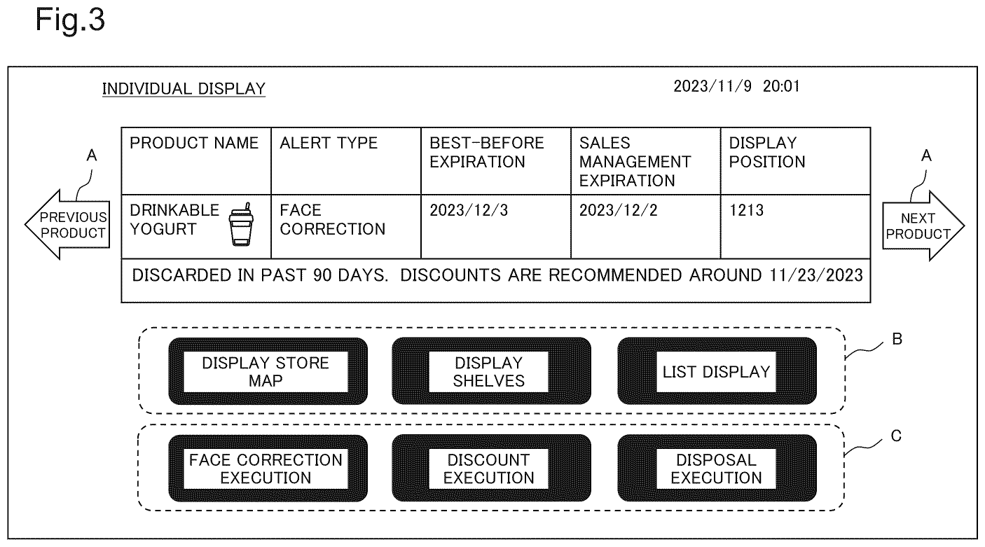

FIG. 3 is an example of a screen on which the output unit 104 has generated an alert of a specific product. In the example of FIG. 3, the output unit 104 displays the product name and the product image of the alert target product, the alert type, the best-before expiration, and the sales management expiration. In the example of FIG. 3, the fact that the product has been discarded in the past and the date on which the discount of the product is recommended are displayed. In the example of FIG. 3, an icon A for displaying other alert target products is provided. In the example of FIG. 3, an icon B for changing information displaying the product is provided. When “display store map” and “display shelves” are selected, the output unit 104 displays places where products are displayed, and when “list display” is selected, a list of alert target products is displayed. In the example of FIG. 3, an icon C is provided to register work completed by the store clerk. When any of the icons indicating the work names is selected, the output unit 104 may delete the alert of the product. In the example of FIG. 3, the alert of the product is deleted by selecting the icon of “face correction execution”. In a case where any of the icons indicating the work names is selected, it is considered that the possibility of including the expired product due to the work of the store clerk becomes low. Therefore, the determination unit 103 may subtract a score value indicating the possibility of including a product whose sales management expiration has expired according to the work name of the selected icon C. This makes it possible to more accurately evaluate the possibility of including expired products.

However, the alert output by the output unit 104 is not limited to the example of FIG. 3.

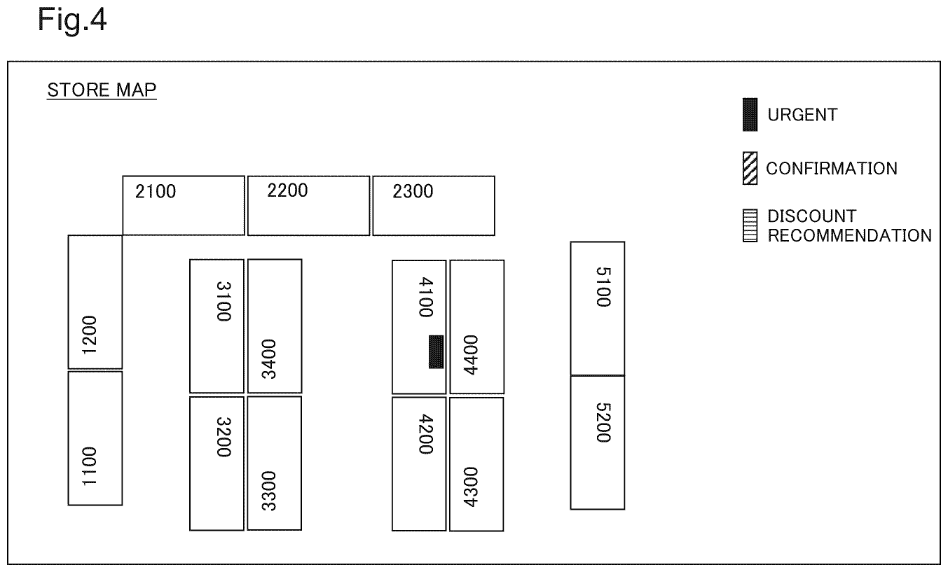

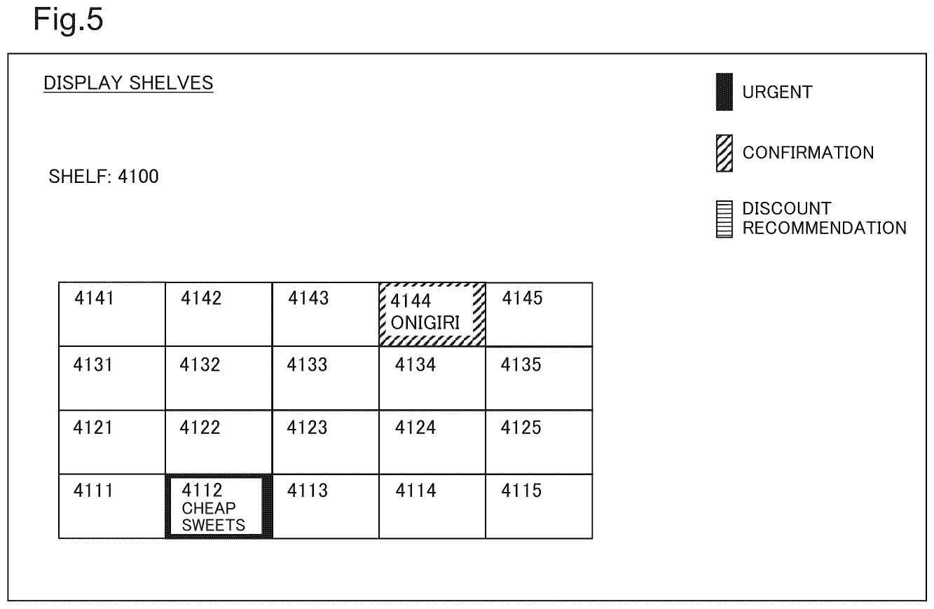

FIGS. 4 and 5 are other examples of the screen on which the output unit 104 has generated the alert. In the example of FIG. 4, the position of the product shelf of the product for which the alert has occurred is displayed on the store map showing the layout of the product shelf. In the example of FIG. 5, the display position of the alert target product on the display shelf is displayed. In the examples of FIGS. 4 and 5, the output unit 104 displays “urgent”, “confirmation”, and “discount recommendation” as types of alerts.

FIG. 6 is a flowchart illustrating an outline of the operation of the product management device 100 according to the present disclosure. The processing according to this flowchart may be executed based on program control by the processor described above. The processing according to this flowchart is performed at an arbitrary timing, and is performed, for example, at a timing before the replenishment work by the store clerk.

FIG. 6 is a flowchart illustrating the operation of the product management device 100 according to the present disclosure. The first acquisition unit 101 acquires shelf monitoring information indicating a change in a display status of a product included in a photographed image based on the photographed image obtained by photographing the product shelf (step S101). Next, the second acquisition unit 102 acquires the sales management information of the product (step S102). Next, the determination unit 103 determines a criterion for generating an alert based on a possibility of including a product whose sales management expiration has expired, the possibility being evaluated based on the shelf monitoring information and the sales management information (step S103). Finally, the output unit 104 generates an alert of a product based on the criterion (step S104). Thus, the product management device 100 ends the product management processing.

As described above, in the product management device 100 of the present disclosure, the determination unit 103 determines a criterion for generating an alert based on a possibility of including a product whose sales management expiration has expired, the possibility being evaluated based on the shelf monitoring information and the sales management information. Then, the output unit 104 generates an alert of the product based on the criterion. Therefore, the management expiration can be appropriately managed regardless of the display status of the product.

### Modification of First Example Embodiment

Next, a modification of the first example embodiment of the present disclosure will be described in detail with reference to the drawings. Hereinafter, description of contents overlapping with the above description will be omitted to the extent that the description of the present example embodiment is not unclear.

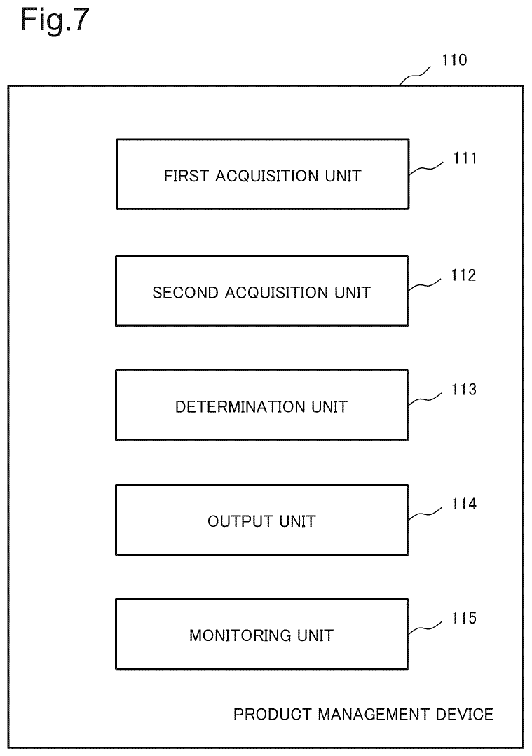

FIG. 7 is a block diagram illustrating a configuration example of a product management device 110 according to a modification of the first example embodiment. Referring to FIG. 7, the product management device 110 includes a monitoring unit 115 in addition to a first acquisition unit 111, a second acquisition unit 112, a determination unit 113, and an output unit 114. In the present modification, it is assumed that the first acquisition unit 111 detects an action disturbing a display status of a product by a customer.

The monitoring unit 115 is a means that monitors the action of the monitoring customer who has performed the action that disturbs the display status of the product. For example, the monitoring unit 115 tracks the monitoring customer moving in the store using a known technique based on the face image data of the monitoring customer photographed by a camera installed in the store, and monitors the action of the monitoring customer until the customer leaves the store.

The first acquisition unit 111 detects an action by the monitoring customer which disturbs the display status of the product. Then, in a case where an action of the monitoring customer which disturbs the display status of the product is detected by the first acquisition unit 111, the determination unit 113 may make a criterion for generating an alert of the product whose display has been disturbed by the monitoring customer more likely to occur than a predetermined criterion. That is, the determination unit 113 determines a criterion for generating an alert based on the possibility of including a product whose sales management expiration has expired, the possibility being evaluated based on the shelf monitoring information, the sales management information, and the action of the monitoring customer.

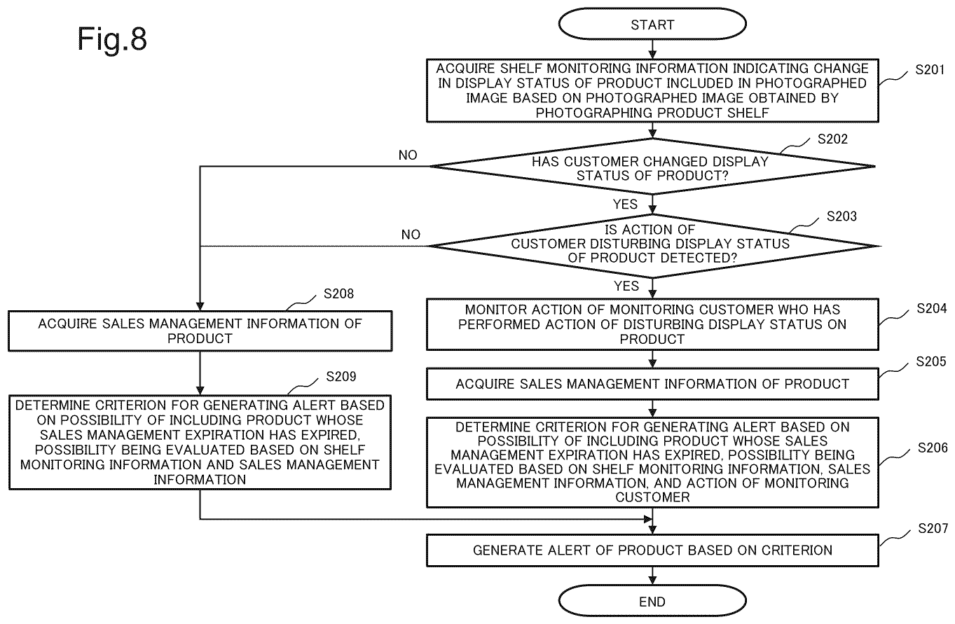

FIG. 8 is a flowchart illustrating the operation of the product management device 110 in the present disclosure. The first acquisition unit 111 acquires shelf monitoring information indicating a change in a display status of a product included in a photographed image based on the photographed image obtained by photographing the product shelf (step S201). In a case where the customer changes the display status of the product by the first acquisition unit 111 (S202; YES), and an action of the customer disturbing the display status of the product is detected (S203; YES), the monitoring unit 115 monitors the action of the monitoring customer who has performed the action of disturbing the display status on the product (step S204). Next, the second acquisition unit 112 acquires the sales management information of the product (step S205). Next, the determination unit 113 determines a criterion for generating an alert based on the possibility of including a product whose sales management expiration has expired, the possibility being evaluated based on the shelf monitoring information, the sales management information, and the action of the monitoring customer (step S206). Finally, the output unit 114 generates an alert of a product based on the criterion (step S207).

On the other hand, in a case where the change in the display status of the product is made by the store clerk in S202 (S202; NO), or in a case where an action of the customer disturbing the display status of the product is not detected in S203 (S203; NO), the flow proceeds to S208. That is, the second acquisition unit 112 acquires the sales management information of the product (step S208). Next, the determination unit 113 determines a criterion for generating an alert based on a possibility of including a product whose sales management expiration has expired, the possibility being evaluated based on the shelf monitoring information and the sales management information (step S209). Finally, the output unit 114 generates an alert of a product based on the criterion (step S207).

As described above, in the product management device 110 of the present disclosure, in a case where the first acquisition unit 111 detects that the customer changes the display status of the product and an action of the customer disturbing the display status of the product, the monitoring unit 115 monitors an action of the monitoring customer who has performed an action disturbing the display status on the product. Then, the determination unit 113 determines a criterion for generating an alert based on the possibility of including a product whose sales management expiration has expired, the possibility being evaluated based on the shelf monitoring information, the sales management information, and the action of the monitoring customer. As a result, for example, it is possible to determine a criterion for generating an alert in consideration of an action of a customer disturbing a display status of a product. Therefore, even if the display status of the product is disturbed by a specific customer, the management expiration can be appropriately managed.

There is a technique for managing an expiration date and a best-before expiration of a product sold in a store. The display status may be disturbed due to replenishment of products or the like. However, in the technique described in Patent Literature 1, the sales management expiration cannot be grasped unless the identification tag faces the placement platform surface side (the surface of the shelf board).

Although the present disclosure has been particularly illustrated and described with reference to the present example embodiment, the present disclosure is not limited to the above example embodiment. The configuration and details of each present disclosure may include example embodiments to which various changes that can be grasped by those skilled in the art within the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations are described in order in the form of a flowchart, the order of description does not limit the order of executing the plurality of operations. Therefore, when each example embodiment is implemented, the order of the plurality of operations can be changed within a range that does not interfere with the content.

### SUPPLEMENTARY NOTE

Some or all of the above example embodiments may be described as the following Supplementary Notes, but are not limited to the following.

### Supplementary Note 1

A product management device including:
a first acquisition means for acquiring shelf monitoring information indicating a change in a display status of a product included in a photographed image based on the photographed image obtained by photographing a product shelf;
a second acquisition means for acquiring sales management information of a product;
a determination means for determining a criterion for generating an alert based on a possibility of including a product whose sales management expiration has expired, the possibility being evaluated based on the shelf monitoring information and the sales management information; and
an output means for generating an alert of the product based on the criterion.

### Supplementary Note 2

The product management device according to Supplementary Note 1, in which the first acquisition means further specifies whether the change in the display status of the product is made by a customer or a store clerk, and in a case where the change is made by the customer, detects an action that disturbs the display status of the product.

### Supplementary Note 3

The product management device according to Supplementary Note 2, in which an action of disturbing the display status is any one of that the product is picked up from a back side of a product shelf, that a product picked up by hand is returned to the product shelf, or that another product is placed.

### Supplementary Note 4

The product management device according to Supplementary Note 1, in which the first acquisition means further specifies whether the change in the display status of the product is made by a customer or a store clerk, and in a case where the change is made by the store clerk, detects an action that corrects the display status of the product.

### Supplementary Note 5

The product management device according to Supplementary note 4, in which an action of correcting the display status is either alignment of products or face correction of products.

### Supplementary Note 6

The product management device according to any one of Supplementary Notes 1 to 5, in which in a case where a number of times of detecting an action disturbing the display status of the product is equal to or greater than a predetermined number of times, the determination means sets the criterion for generating the alert to be lower than a preset criterion, and in a case where a number of times of detecting an action of correcting the display status of the product is equal to or greater than a predetermined number of times, the determination means sets the criterion for generating the alert to be higher than the preset criterion.

### Supplementary Note 7

The product management device according to Supplementary Note 1, in which
the first acquisition means further acquires information of a caution-needed product for which confirmation of the sales management expiration is more necessary, and
the determination means sets a criterion of an alert of a sales management expiration of the caution-needed product to be lower than a preset criterion.

### Supplementary Note 8

The product management device according to Supplementary Note 2, further including
a monitoring means for monitoring an action of a monitoring customer who has acted to disturb the display status of the product, in which
the determination means determines the criterion for generating the alert based on the possibility of including the product whose sales management expiration has expired, the possibility being evaluated based on the shelf monitoring information, the sales management information, and an action of the monitoring customer.

### Supplementary Note 9

A product management method for causing a computer to execute:
acquiring shelf monitoring information indicating a change in a display status of a product included in a photographed image based on the photographed image obtained by photographing a product shelf;
acquiring sales management information of the product;
determining a criterion for generating an alert based on a possibility of including a product whose sales management expiration has expired, the possibility being evaluated based on the shelf monitoring information and the sales management information; and
generating an alert of the product based on the criterion.

### Supplementary Note 10

A program for causing a computer to execute:
acquiring shelf monitoring information indicating a change in a display status of a product included in a photographed image based on the photographed image obtained by photographing a product shelf;
acquiring sales management information of the product;
determining a criterion for generating an alert based on a possibility of including a product whose sales management expiration has expired, the possibility being evaluated based on the shelf monitoring information and the sales management information; and
generating an alert of the product based on the criterion.

Some or all of the configurations described in Supplementary Notes 2 to 8 dependent on Supplementary Note 1 described above can also depend on Supplementary Notes 9 and 10 in the same dependency relationship as the Supplementary Notes 2 to 8. Not only Supplementary Notes 1, 9, and 10 but also various pieces of hardware, software, and various recording medium for recording software, or a system can be similarly dependent on some or all of the configurations described as Supplementary Notes without departing from the above-described example embodiments.

1. A product management device comprising:
a memory storing instructions; and
a processor connected to the memory and configured to execute the instructions to:
acquire shelf monitoring information indicating a change in a display status of a product included in a photographed image based on the photographed image obtained by photographing a product shelf;
acquire sales management information of the product;
determine a criterion for generating an alert based on a possibility of including a product whose sales management expiration has expired, the possibility being evaluated based on the shelf monitoring information and the sales management information; and
generate an alert of the product based on the criterion.

2. The product management device according to claim 1, wherein the processor is configured to further execute the instructions to:
specify whether the change in the display status of the product is made by a customer or a store clerk, and in a case where the change is made by the customer, detect an action that disturbs the display status of the product.

3. The product management device according to claim 2, wherein
an action of disturbing the display status is any one of that the product is picked up from a back side of a product shelf, that a product picked up by hand is returned to the product shelf, or that another product is placed.

4. The product management device according to claim 1, wherein the processor is configured to further execute the instructions to:
specify whether the change in the display status of the product is made by a customer or a store clerk, and in a case where the change is made by the store clerk, detect an action that corrects the display status of the product.

5. The product management device according to claim 4, wherein
an action of correcting the display status is either alignment of products or face correction of products.

6. The product management device according to claim 1, wherein the processor is configured to execute the instructions to:
in a case where a number of times of detecting an action disturbing the display status of the product is equal to or greater than a predetermined number of times, set the criterion for generating the alert to be lower than a preset criterion, and in a case where a number of times of detecting an action of correcting the display status of the product is equal to or greater than a predetermined number of times, set the criterion for generating the alert to be higher than the preset criterion.

7. The product management device according to claim 1, wherein the processor is configured to further execute the instructions to:
acquire information of a caution-needed product for which confirmation of the sales management expiration is more necessary, and
set a criterion of an alert of a sales management expiration of the caution-needed product to be lower than a preset criterion.

8. The product management device according to claim 2, wherein the processor is configured to execute the instructions to:
monitor an action of a monitoring customer who has acted to disturb the display status of the product; and
determine the criterion for generating the alert based on the possibility of including the product whose sales management expiration has expired, the possibility being evaluated based on the shelf monitoring information, the sales management information, and an action of the monitoring customer.

9. A product management method by a computer, the product management method comprising:
acquiring shelf monitoring information indicating a change in a display status of a product included in a photographed image based on the photographed image obtained by photographing a product shelf;
acquiring sales management information of the product;
determining a criterion for generating an alert based on a possibility of including a product whose sales management expiration has expired, the possibility being evaluated based on the shelf monitoring information and the sales management information; and
generating an alert of the product based on the criterion.

10. A non-transitory computer-readable recording medium that records a program for causing a computer to execute:
acquiring shelf monitoring information indicating a change in a display status of a product included in a photographed image based on the photographed image obtained by photographing a product shelf;
acquiring sales management information of the product;
determining a criterion for generating an alert based on a possibility of including a product whose sales management expiration has expired, the possibility being evaluated based on the shelf monitoring information and the sales management information; and
generating an alert of the product based on the criterion.
